(19) United States
(12) Patent Application Publication
(10) Pub. No.: US 2020/0324513 A1
(43) Pub. Date: Oct. 15, 2020

(54) RECYCLABLE FILMS FOR PRODUCT PACKAGING

(71) Applicant: Bemis Company, Inc., Neenah, WI (US)

(72) Inventors: Zheng Tian, Neenah, WI (US); Otacilio T. Berbert, Oshkosh, WI (US); Daniel C. Vennerberg, Neenah, WI (US); Thomas A Schell, Winneconne, WI (US); Rebecca M. Mick, Appleton, WI (US)

(21) Appl. No.: 16/959,076

(22) PCT Filed: Dec. 29, 2017
(86) PCT No.: PCT/US2017/068881

§ 371 Date: Jun. 29, 2020

(51) Int. Cl. B32B 7/02; B32B 27/08; B32B 27/32

(52) U.S. Cl. CPC B32B 7/02; B32B 27/32; B32B 27/08

(57) ABSTRACT

Recyclable films for packaging a product have a composition comprising a polyethylene, and the film is oriented and irradiatively cross-linked. The recyclable films have excellent heat resistant properties, Multilayer films for packaging a product comprise an outer film comprising any recyclable film of the disclosure and a sealant layer or film. Onset of sticking by an outer surface of the recyclable film upon exposure to heat sealing conditions is at least 5 to 15° C. higher than a comparative outer surface of a comparative outer film comprising the polyethylene that is not oriented and irradiatively cross-linked.

### TECHNICAL FIELD

The present disclosure relates generally to primary packaging for products such as food and/or beverage, Specifically, films that are considered recyclable have improved heat resistance properties. Packages made from the recyclable films are also provided.

### BACKGROUND

Stand-up pouches (SUP) for beverage packaging typically use oriented polyethylene terephthalate (OPET) or biaxially-oriented nylon (BON) for outer layers, which provide high stiffness, printing quality and heat resistance. Without any additional compatibilizing chemicals, however, both OPET and BON are not recyclable in current recycling streams.

Utilizing recyclable food packaging is a goal for many consumers and food packagers. In particular, recyclable SUP structures are desirable for compliance purposes. It is understood that a polyethylene structure is a way to provide recyclable films. Polyethylene (PE) structures typically have low stiffness and limited heat resistance, To improve the initial low stiffness and heat sealing performances of PE, some PE films of the prior art are machine-oriented but exhibit drawbacks with respect to heat resistance and stiffness.

There is a continuing need for films that are recyclable while also providing excellent mechanical properties and heat resistance.

### SUMMARY

Provided are recyclable films and packages made therefrom. The recyclable films disclosed herein provide excellent mechanical properties and heat resistance. Recyclable films that are oriented and irradiatively cross-linked show improved properties with respect to heat resistance, clarity, and shrinkage as compared to films of the same compositions that are not both oriented and irradiatively cross-linked.

In a first aspect, a recyclable film for packaging a product has a composition comprising a polyethylene, the film being oriented and irradiatively cross-linked. The composition may be selected from the group consisting of: high density polyethylene, medium density polyethylene, low density polyethylene, linear low density polyethylene, and combinations thereof.

The recyclable film may have a clarity of at least 95%.

The recyclable film may exhibit a change in apparent shear viscosity that is substantially constant over an apparent shear rate in the range of 1 s⁻¹ to 100,000 s⁻¹.

An outer surface of the film may have a cross-link density that is higher than a comparative outer surface of a comparative outer film comprising the polyethylene that is not irradiatively cross-linked.

Onset of sticking by an outer surface of the film upon exposure to heat sealing conditions may be at least 5 to 15° C. higher than a comparative outer surface of a comparative outer film comprising the polyethylene that is not irradiatively cross-linked.

The recyclable film may have a shrink rate of 10% or less upon application of heat greater than or equal to 90° C.

The recyclable film may comprise a monolayer of one type of polyethylene or a blend of two or more types of polyethylene. The recyclable film may comprise a coextruded multilayered laminate. The coextruded multilayered laminate may comprise a medium density polyethylene layer positioned between an outer high density polyethylene layer and an inner high density polyethylene layer. The outer and inner layers of the coextruded multilayered laminate may further comprise a linear low density polyethylene.

Another aspect is a multilayer film for packaging a product comprising: an outer film comprising any recyclable film of the disclosure; a sealant layer or film; and optionally one or more inner layers located between the outer film and the sealant layer or film. The sealant layer may comprise a polyolefin. The outer film and the sealant layer may be coextruded. The sealant film may comprise at least a polyolefin layer. The outer film and the sealant film may be laminated by heat, extrusion, or by adhesive. The multilayer film may have a thickness in the range of about 125 microns (0.5 mil) to about 380 microns (15 mils). The multilayer film may further comprise printed indicia.

A further aspect is a package for food and/or beverage comprising any recyclable film of the disclosure or any multilayer film of the disclosure. The package may be in the form of a pouch comprising one or more sidewalls formed from the multilayer film.

In another aspect, a method of making a food and/or beverage package comprises: extruding a polyethylene to form a film; orienting the film in a machine direction; and irradiating the film, thereby forming cross-links in at least an outer surface of the film; and forming the food and/or beverage package from the oriented and irradiatively cross-linked film. The method may further comprise coextruding a sealant layer on the oriented and irradiatively cross-linked film and forming the food and/or beverage package therefrom. The method may further comprise laminating a sealant film to the oriented and irradiatively cross-linked film and forming the food and/or beverage package therefrom. In the method, the irradiating may be conducted under conditions of about 2 to about 24 MRad.

These and other aspects of the disclosure are described in the detailed description below. In no event should the above summary be construed as a limitation on the claimed subject matter.

### BRIEF DESCRIPTION OF THE DRAWINGS

The disclosure may be more completely understood in consideration of the following detailed description of various embodiments of the disclosure in connection with the accompanying drawings, in which:

FIGS. 1-2 are cross-sectional views of exemplary recyclable films;

FIG. 3 is a cross-sectional view of an exemplary multilayer film including a recyclable film;

FIG. 4 is a logarithmic graph of gel density comparison by viscosity; and

FIGS. 5-8 are differential scanning calorimetry (DSC) graphs of heat flow versus temperature for Examples 1, 5, 3, 6, respectively,

The figures are not necessarily to scale. Like numbers used in the figures refer to like components. It will be understood, however, that the use of a number to refer to a component in a given figure is not intended to limit the component in another figure labeled with the same number.

### DETAILED DESCRIPTION

Films of the present disclosure are recyclable and provide improved heat resistance and clarity. The recyclable films are oriented and irradiatively cross-linked. The recyclable films exhibit limited shrinkage upon exposure to heat sealing conditions. Higher heat resistance of the disclosed films allows for better converting on existing heat sealing machines. It is understood that there is an approximate 15° C. (˜10° C.) difference of any given commercial heat sealing process due to variability of the thermostats that control heat bars of the heat sealing machines. The greater heat resistance of the disclosed recyclable films can tolerate the heat bar temperature variability better than current films.

A “layer” as used herein refers to a building block of sidewalls that is a structure of a single polymer-type or a blend of polymers or that may have an additive.

Reference to “outer surface” or “outer layer” or “outer film” as used herein refers to the portion of a package that is located outermost of all the surfaces, layers, or films respectively of the package.

Reference to an “inner surface” means the surface of a layer away from the outer surface and towards the interior where the product is packaged.

An “inner layer” as used herein refers to a layer that is not exposed to handling and the environment. Inner layers may provide functionality as needed for particular applications. Inner layers generally allow for thermoforming of the entire film. In addition, inner layers may provide barrier protection and/or structural strength. An exemplary inner layer is a barrier layer, which provides protection to packaged food for freshness and/or a barrier to moisture and/or oxygen. Barrier layers may also protect outer films/layers from migration from package contents (for example, oils and the like). An exemplary inner layer may also be a structural layer, which provides one or more of: general durability, puncture strength, resistance to curling, and flex crack resistance.

A “sealant layer” is one that seals to itself or another film to form a hermetic seal. That is, the sealant layer comprises a thermoplastic polymer or polymer mixture that softens when exposed to heat and returns to its original condition when cooled to room temperature. A “sealant film” has at least one exposed sealant surface that is sealable to itself or another film to form a hermetic seal.

As used herein, the term “polymer” refers to the product of a polymerization reaction, and is inclusive of homopolymers, copolymers, terpolymers, etc. In general, the layers of a film can consist essentially of a single polymer, or can have still additional polymers together therewith, i.e., blended therewith.

As used herein, the term “copolymer” refers to polymers formed by the polymerization of reaction of at least two different monomers. As used herein, a copolymer identified in terms of a plurality of monomers, e.g., “propylene/ethylene copolymer” refers to a copolymer in which either monomer may copolymerize in a higher weight or molar percent than the other monomer or monomers. However, the first listed monomer preferably polymerizes in a higher weight percent than the second listed monomer.

As used herein, terminology employing a “/” with respect to the chemical identity of a copolymer (e.g., ethylene/vinyl alcohol copolymer), identifies the comonomers that are copolymerized to produce the copolymer.

“Polyethylene” is the name for a polymer whose basic structure is characterized by the chain- (CH2-CH2-)n. Polyethylene homopolymer is generally described as being a solid which has a partially amorphous phase and partially crystalline phase with a density of between 0.915 to 0.970 g/cm³. The relative crystallinity of polyethylene is known to affect its physical properties. The amorphous phase imparts flexibility and high impact strength while the crystalline phase imparts a high softening temperature and rigidity.

The term “tie layer,” “adhesive layer,” or “adhesive coating,” refers to a material placed on one or more layers, partially or entirely, to promote the adhesion of that layer to another surface, Preferably, adhesive layers or coatings are positioned between two layers of a multilayer film to maintain the two layers in position relative to each other and prevent undesirable delamination. Unless otherwise indicated, a tie layer or an adhesive layer or coating can have any suitable composition that provides a desired level of adhesion with the one or more surfaces in contact with the adhesive layer material. Optionally, a tie layer or an adhesive layer or coating placed between a first layer and a second layer in a multilayer film may comprise components of both the first layer and the second layer to promote simultaneous adhesion of the adhesive layer to both the first layer and the second layer to opposite sides of the adhesive layer.

A “sidewall” is a discrete piece of polymer film or multi-layer laminate that is sealed to itself or another sidewall by, for example, welding or an adhesive, to form a pouch or a bag.

“Heat sealing conditions” refer to residence time and temperature that are suitable for a sealant layer or sealant surface to adhere to itself.

As used herein, the term “cross-linking” refers to the chemical reaction which results in the formation of bonds between polymer chains, such as, but not limited to, carbon-carbon bonds. Cross-linking may be accomplished by use of a chemical agent or combination thereof which may include, but is not limited to, for example, peroxide, silanes and the like, and ionizing radiation, which may include, but is not limited to, high energy electrons, gamma-rays, beta particles and ultraviolet radiation. The irradiation source can be any electron beam generator operating in a range of about 150-6000 kilovolts (6 megavolts) with a power output capable of supplying the desired dosage. The voltage can be adjusted to appropriate levels which may be, for example, 1-6 million volts or higher or lower. Many apparatus for irradiating films are known to those skilled in the art. In general, the most preferred amount of radiation is dependent upon the film structure and its total thickness. One method for determining the degree of “cross-linking”, e.g., “cross-link density” or the amount of radiation absorbed by a material is to measure the “gel content.” As used herein, the term “gel content” refers to the relative extent of cross-linking within a polymeric material. Gel content is expressed as a relative percent (by weight) of the polymer having formed insoluble carbon-carbon bonds between polymers and may be determined by ASTM D-2765-01 Test Method, which is incorporated herein by reference in its entirety, Another method for determining the relative degree of cross-linking or gel content is with capillary viscometry. The apparent shear viscosity of the polymer is measured with respect to the apparent shear rate of the polymer. This measure is representative of the relative degree of cross-linking as it is known that viscosity increases as the level of cross-linking increases. The capillary viscometry test method is further described herein

### Recyclable Films

Recyclable films, as well as packages and/or containers including such films, preferably have seal strength, stability, heat resistance, and oxygen and water vapor transmission properties that allow them to be subjected to heat sealing conditions without loss of desired functional characteristics. Recyclable films that are oriented and irradiatively cross-linked show improved properties with respect to heat resistance, clarity, and shrinkage as compared to films of the same compositions that are not oriented and irradiatively cross-linked.

The recyclable films may be monolayer or multilayered laminates which include a polyethylene-based polymer or copolymer or blends of different types of polyethylene-based polymers, There are several broad categories of polymers and copolymers referred to as “polyethylene.” Placement of a particular polymer into one of these categories of “polyethylene” is frequently based upon the density of the “polyethylene” and often by additional reference to the process by which it was made since the process often determines the degree of branching, crystallinity and density. In general, the nomenclature used is nonspecific to a compound but refers instead to a range of compositions. This range often includes both homopolymers and copolymers.

“High density” polyethylene (HDPE) is ordinarily used in the art to refer to both (a) homopolymers of densities between about 0.960 to 0.970 g/cm and (b) copolymers of ethylene and an α-olefin (usually 1-butene or 1-hexene) which have densities between 0.940 and 0.958 g/cm³. HDPE includes polymers made with Ziegler or Phillips type catalysts and is also said to include high molecular weight “polyethylenes.”

“Medium-density” polyethylene (MDPE) typically has a density from 0.928 to 0.940 g/cm³.

Another grouping of polyethylene is “high pressure, low density polyethylene” (LDPE). LDPE is used to denominate branched homopolymers having densities between 0.915 and 0.930 g/cm³. LDPEs typically contain long branches off the main chain (often termed “backbone”) with alkyl substituents of 2 to 8 carbon atoms.

Linear Low Density Polyethylene (LLDPE) are copolymers of ethylene with alpha-olefins having densities from 0.915 to 0.940 g/cm³. The a-olefin utilized is usually 1-butene, 1-hexene, or 1-octene and Ziegler-type catalysts are usually employed (although Phillips catalysts are also used to produce LLDPE having densities at the higher end of the range, and metallocene and other types of catalysts are also employed to produce other well-known variations of LLDPEs). An LLDPE produced with a metallocene or constrained geometry catalyst is often referred to as “mLLDPE”.

When the recyclable film is a monolayer, it is preferably a HDPE.

When the recyclable film is a multilayered laminate, preferably a combination of at least a HDPE and a MDPE is used. In an embodiment, the multilayered laminate has the following design: HDPE/MDPE/HDPE. In another embodiment, the multilayered laminate has the following design: HDPE-mLLDPE/MDPE/HDPE-mLLDPE.

Recyclable films disclosed herein are suitable for “Store Drop-off” recycling streams. These streams may accept the following: 100% polyethylene (PE) bags, wraps, and films; very close to 100% PE bags, wraps, and films that have passed recyclability tests by Trex®; and How2Recycle-approved PE-based carrier packing with compatiblizer technology.

In one or more embodiments, the recyclable films are 100% polyethylene. The recyclable films may have a composition that is selected from the group consisting of: high density polyethylene, medium density polyethylene, low density polyethylene, linear low density polyethylene, and combinations thereof. The recyclable films may consist essentially of polyethylene homopolymers of one or more densities. The recyclable films may consist of polyethylene homopolymers of one or more densities.

The recyclable film may have a clarity of at least 95%, at least 95.5%, at least 96%, at least 96.5%, at least 97%, at least 97.5%, at least 98%, at least 98.5%, at least 99%, at least 99.5%, or 100%, and all values therebetween.

The electron beam (EB) treatment of, for example, an outer surface of the recyclable film leads to improved properties relative to a comparative outer surface of a comparative outer film that is not oriented and irradiatively cross-linked. For example, change in apparent shear viscosity is substantially constant over an apparent shear rate in the range of 1 s⁻¹ to 100,000 s⁻¹ for outer surfaces of the films of the disclosure. Also, the recyclable films are improved such that an outer surface of the film has a cross-link density that is higher than a comparative outer surface of a comparative outer film comprising the polyethylene that is not oriented and irradiatively cross-linked.

In addition, the recyclable films are improved such that onset of sticking by an outer surface of the film upon exposure to heat sealing conditions is at least to 15° C. higher than a comparative outer surface of a comparative outer film comprising the polyethylene that is not oriented and irradiatively cross-linked. The improvement may be at least 6° C., 7° C., 8° C., 9° C., 10° C., 11° C., 12° C., 13° C., 14° C., or 15° C. higher.

The recyclable film may have a shrink rate of 10% or less than 10% upon application of heat greater than or equal to 90° C.; or less than 9%, less than 8%, less than 7%, less than 6%, less than 5%, less than 4%, less than 3%, less than 2%, or less than 1%.

The recyclable films may be used as-formed to fabricate food and/or beverage packages. When the recyclable films are used to fabricate food and/or beverage packages, the inner surface of the film is of a composition or treated to be a sealant. Printing of the recyclable films may be on the outer surface when the recyclable films are a monolayer. For multilayered laminate recyclable films, printing may be on either side of an outer layer of the multilayered laminate.

The recyclable films may be used as an outer layer in a multilayer film to fabricate food and/or beverage packages.

### Multilayer Films

Multilayer films for fabricating food and/or beverage packages may include any recyclable film disclosed herein. The recyclable film is used as an outer layer of the multilayer films for packaging. The recyclable film may be monolayer or a multilayered laminate. The multilayer films for packaging may be without limit, 2-ply, 3-ply, or more. In an embodiment, a sealant layer is coextruded or adhered to a recyclable film to form the multilayer film for packaging. Between the sealant layer and the recyclable film, any number of optional inner layers may be provided. Sealant layer and any further inner layers can be made from recyclable materials in order to form an entire multilayer film that is considered recyclable. However, there is not a requirement that the sealant layer and any further inner layers be made from recyclable materials.

### Sidewall Materials

A sidewall is typically formed from a recyclable film as disclosed herein or a multilayered film that includes the recyclable film. In general terms, there is at least an outer layer or film, and a sealant layer. Optionally, one or more an inner (or barrier) layers may be present between the outer layer or film and the sealant layer.

In general, the sealant layer may comprise any suitable thermoplastic material including, but not limited to, synthetic polymers such as polyesters, polyamides, polyolefins, polystyrenes, and the like. Thermoplastic materials may also include any synthetic polymers that are cross-linked by either radiation or chemical reaction during a manufacturing or post-manufacturing process operation. Exemplary polyolefins include polyethylene (PE) and polypropylene (PP).

A layer having an ethylene/vinyl alcohol (“EVOH”) copolymer film provides oxygen barrier protection and may be suitable in an inner layer such as a barrier layer. A foil film, such as aluminum foil, also provides oxygen barrier protection and may be suitable alone or in combination with other films in an inner layer such as a barrier layer.

Between any of the layers, an adhesive coating or layer may be provided to provide adhesion and continuity between the layers. Adhesive compositions of the disclosure may include, but are not limited to: modified and unmodified polyolefins, preferably polyethylene, most preferably, ethylene/α-olefin copolymer, modified and unmodified acrylate resin, preferably selected from the group consisting of ethylene/vinyl acrylate copolymer, ethylene/ethyl acrylate copolymer, ethylene/butyl acrylate copolymer, or blends thereof. EVA is an ethylene/vinyl acetate co-polymer, which may be used in particular to form a layer to facilitate bonding of polymerically dissimilar layers,

### Fabrication

A monolayer recyclable PE film may be formed by extruding resins of a PE or of a blend of PEs through a die to obtain a film.

A multilayered laminate recyclable PE film may be formed by co-extruding two or more sources of resins of a PE or of a blend of PEs through two or more individual dies to obtain a multilayered laminate film.

Blown films are wound to make one collapsed bubble roll or slit and wound to make two finished rolls. The recyclable films are treated by the combination of an electron beam and machine orientation, in any order.

The films are exposed to an electron beam (E-beam, EB) treatment, Treatment takes place on one side of the film, typically the outer surface but treatment can occur on either side, as it is expected that the crosslinking takes place throughout the entire film thickness. The outer surface/layer is directly exposed to a heat bar/sealing mechanism during fabrication of a package. The irradiating by E-beam (EB) is conducted under conditions of about 2 to about 24 MRad, and all values inbetween. Conditions for EB may be in the range of about to about 20 MRad, or preferably about 9 MRad.

A layer of the film to receive print indicia is optionally corona-treated.

The films are stretched in a machine direction orientation (MDO) by methods understood in the art.

To form a package, a sealing layer of any film disclosed herein is adhered to itself or another film to form a seam of a sidewall, Packages may further include indicia in their films.

Before describing several exemplary embodiments of the disclosure, it is to be understood that the disclosure is not limited to the details of construction or process steps set forth in the following description. The disclosure is capable of other embodiments and of being practiced or being carried out in various ways.

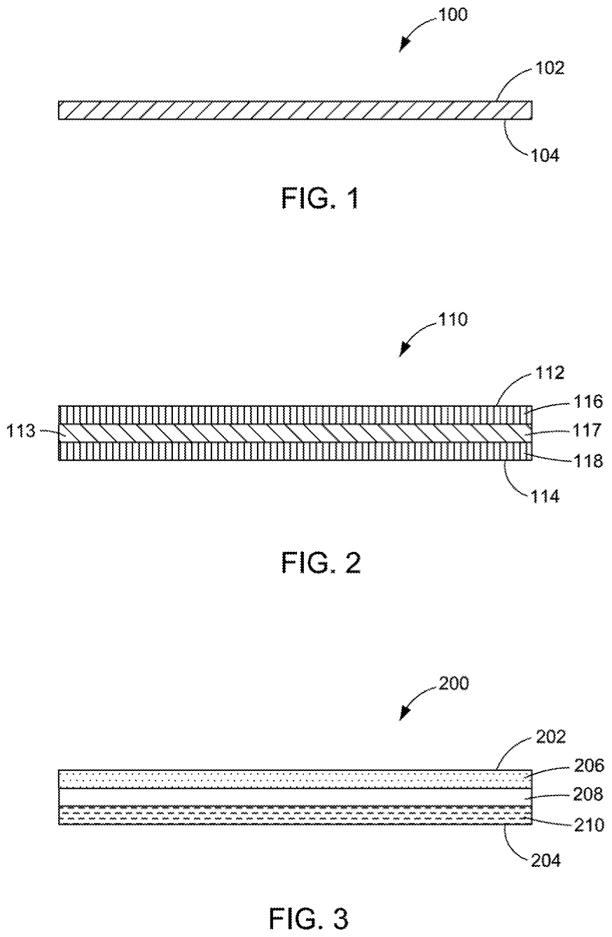

Turning to the figures, FIG. 1 is a cross-sectional view of an exemplary recyclable film 100 having a composition that is polyethylene-based, without restriction. The embodiment of FIG. 1 is a monolayer, which is a monoextrusion of a polymer resin or blend of resins. The composition may comprise a single type of polyethylene, for example HDPE. The composition of recyclable film 100 may comprise a blend of types of polyethylene, for example HDPE and mLLDPE. The recyclable film 100 has a first surface 102 and a second surface 104. The first surface 102 forms an outer surface of a final package, and the second surface 104 may provide sealant properties. For making a package out of recyclable film 100 only, second surface 104 may be of a composition to provide sealant properties. Printed indicia may be provided on surface 102, which is optionally corona-treated.

FIG. 2 is a cross-sectional view of an exemplary recyclable film 110. The embodiment of FIG. 2 is a multilayer laminate, which is a coextrusion of individual sources of polymer resins or blends of resins. Recyclable film 110 has an outer layer 116, a middle layer 117, and an inner layer 118. The composition of each layer is independently polyethylene-based, without restriction. In a non-limiting embodiment, film 110 comprises an outer layer 116 of HDPE, a middle layer 117 of MDPE, and an inner layer 118 of HDPE. In another non-limiting embodiment, film 110 comprises an outer layer 116 of HDPE and mLLDPE blend, a middle layer 117 of MPE, and an inner layer 118 of HPE and mLLDPE blend. The recyclable film 110 has a first surface 112 and a second surface 114. The first surface 112 forms an outer surface of a final package, and the second surface 114 may provide sealant properties. For making a package out of recyclable film 110 only, second surface 114 may be of a composition to provide sealant properties. For example, layer 118 may comprise a blend of HDPE and mLLDPE blend. Middle layer 117 is optional. Any number of additional layers may be provided between inner layer 118 and outer layer 116. In one or more embodiments, layers 116 and 118 may have the same composition different from that of 117. Printed indicia may be provided on surface 112, which is optionally corona-treated. Reverse printed indicia may be provided on surface 113, which is optionally corona-treated, which is opposite surface 112 of outer layer 116.

A cross-sectional view of an exemplary multilayer film 200 including a recyclable film 206 is provided in FIG. 3. The recyclable film 206 may be a monolayer as provided in FIG. 1, or a multilayer laminate as provided in FIG. 2, Sealant layer 210 may coextruded with recyclable film 206. Optional inner layer 208 may be an adhesive layer to adhere sealant layer 208 adhered to recyclable film 206. Sealant layer is preferably is a composition that is polyolefin-based. The multilayer film 200 may optionally have further inner layers without limit between recyclable film 206 and sealant layer 210. When sealant layer 210 and any further inner layers are made from recyclable materials, then the entire multilayer film 200 may be considered recyclable. It is understood that should there be a need, sealant layer 210 and any further inner layers are not required to be made from recyclable materials. Sealant layer 210 may be a monolayer or a multilayer laminate. First surface 202 forms an outer surface of a final package, which may optionally be corona-treated for receiving indicia.

### EXAMPLES

The following steps were used in the fabrication process of films of Examples 1-6 and 10-11. A resin corresponding to each layer was extruded through a die and the layers were coextruded. Coextruded blown films were slit and wound to make two finished rolls.

In the examples, HDPE-mLLDPE refers to a blend of high density polyethylene and metallocene-catalyzed linear low density polyethylene resins. HDPE refers to a high density polyethylene. MDPE refers to a medium density polyethylene.

MDO refers to stretching films in a machine direction orientation.

EB refers to electron beam treatment of the film.

### Example 1

### Comparative

A 3-layer film structure of HDPE-mLLDPE/MDPE/HDPE-mLLDPE was stretched by MDO and was not exposed to EB treatment. Blown film thickness was 156 micron (625 mil), printing surface was corona-treated, and the MDO ratio was 6:1. Caliper measurement of the MDO film thickness was 31.0 micron (1.24 mils).

### Example 2

A 3-layer film structure of HDPE-mLLDPE/MDPE/HDPE-mLLDPE was first exposed to EB treatment (9 MRad) and then stretched by MDO.

### Example 3

### Comparative

A 3-layer film structure of HDPE/MDPE/HDPE was stretched by MDO and was not exposed to EB treatment. Blown film thickness was 156 micron (6.25 mil), printing surface was corona-treated, and the MDO ratio was 6:1. Caliper measurement of the MDO film thickness was 22.1 micron (0.89 mils).

### Example 4

A 3-layer film structure of HDPE/MDPE/HDPE was first exposed to EB treatment (9 MRad) and then stretched by MDO.

### Example 5

A 3-layer film structure of HDPE-mLLDPE/MDPE/mLLDPE was first stretched by MDO and then was exposed to EB treatment (9 MRad). Blown film thickness was 156 micron (6.25 mil), printing surface was corona-treated, and the MDO ratio was 6:1. Caliper measurement of the MDO film thickness was 30.8 micron (1.23 mils).

### Example 6

A 3-layer film structure of HDPE/MDPE/HDPE was stretched by MDO and was exposed to EB treatment (9 MRad). Blown film thickness was 156 micron (6.25 mil), printing surface was corona-treated, and the MDO ratio was 6:1. Caliper measurement of the MDO film thickness was 26.3 micron (1.05 mils).

### Example 7

### Comparative

A film of biaxially oriented polypropylene (BOPP) was obtained and not treated by either stretching by MO or by exposure to EB treatment.

### Example 8

### Comparative

A film of oriented polyethylene terephthalate (OPET) was obtained, which was not stretched by MDO or exposed to ER treatment. Caliper measurement of the film thickness was 11.8 micron (0.47 mils).

There is no an EXAMPLE 9.

### Example 10

### Comparative

A 3-layer film structure of HDPE/MDPE/HDPE was not exposed to either EB treatment nor stretched by MDO.

### Example 11

A 3-layer film structure of HDPE/MDPE/HDPE was only exposed to EB treatment (9 MRad) but not stretched by MDO,

### Testing

Tables 1A and 1B provide a summary of the thermal stability/heat sealability of the films of Examples 1-7. The initial heat seal test temperature was 240° F. (115° C.) (at 40 PSI, 1 sec). The temperature was increased in S degree increments and the pressure and dwell time were held constant. The film was visually observed at each temperature after being exposed to the heat bar.

TABLE 1A

| | Example 1 | | | |
|---|---|---|---|---|
| | COMPARATIVE | Example 2 | Example 3 | Example 4 |
| Temp. | HDPE-mLLDPE/MDPE/ | HDPE-mLLDPE/MDPE/ | COMPARATIVE | HDPE/MDPE/HDPE |
| ° F. | HDPE-mLLDPE | HDPE-mLLDPE EB | HDPE/MDPE/HDPE | EB followed |
| (° C.) | MDO, no EB | followed by MDO | MDO, no EB | by MDO |
| 240 | Start sticking | Good | Good | Good |
| (115) | | | | |
| 245 | Sticking, shrink | Good | Good | Good |
| (118) | | | | |
| 250 | Sticking, shrink | Shrink | Start sticking | Good |
| (121) | | | | |
| 255 | Sticking, shrink | Start sticking, | Sticking | Good |
| (124) | | shrink | | |
| 260 | X | X | Sticking | Good |
| (127) | | | | |
| 265 | X | X | Sticking, shrink | Start sticking |
| (129) | | | | |
| 270 | X | X | Sticking, shrink | Sticking, shrink |
| (132) | | | | |
| 275 | X | X | X | X |
| (135) | | | | |
| 280 | X | X | X | X |
| (138) | | | | |

TABLE 1B

| | Example 5 | Example 6 | |
|---|---|---|---|
| Temp. | HDPE-mLLDPE/MDPE/ | HDPE/MDP/HDPE | |
| ° F. | HDPE-mLLDPE MDO | MDO followed | Example 7 |
| (° C.) | followed by EB | by EB | BOPP |
| 240 | Good | Good | Good |
| (115) | | | |
| 245 | Good | Good | Good |
| (118) | | | |
| 250 | Good | Good | Good |
| (121) | | | |
| 255 | Good | Good | Good |
| (124) | | | |
| 260 | Tiny shrink | Good | Sticking |
| (127) | | | |
| 265 | Shrink | Good | Sticking, shrink |
| (129) | | | |
| 270 | Shrink, hazy | Good | Sticking, shrink |
| (132) | | | |
| 275 | Shrink, hazy | Shrink | Sticking, shrink |
| (135) | | | |
| 280 | Shrink, hazy | Sticking, shrink | Sticking, shrink |
| (138) | | | |

Sticking = material sticks to heat bar when heat bar is released; sample can be pulled away from heat bar without material remaining stuck to heat bar.
X = failure; material sticks to heat bar even after sample is pulled away from the heat bar.
Shrink = wrinkling; film deformation.
Hazy = visual detection of haze in film

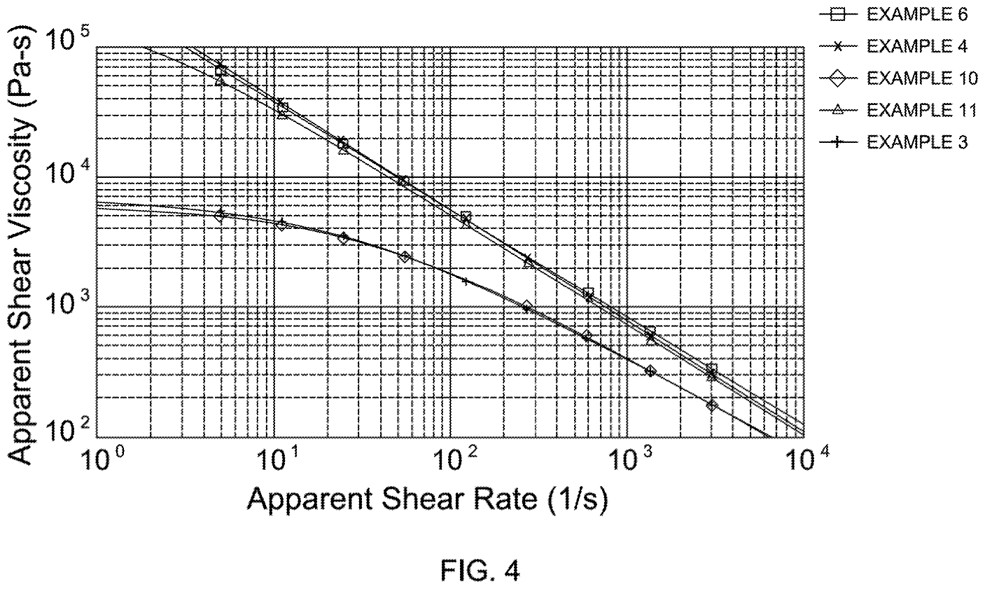

FIG. 4 is a logarithmic graph of gel density comparison by viscosity, showing apparent shear viscosity (Pa-s) versus apparent shear rate (s⁻¹) for Examples 4, 6, and 11; and comparative Examples 3 and 10. For Examples 4 and 6, the change in apparent shear viscosity is substantially constant over an apparent shear rate in the range of 1 s⁻¹ to 100,000 s⁻¹. For the films that have not had an EB treatment (comparative Examples 3 and 10), the change in apparent shear rate is: substantially flat for apparent shear rate of 100 s⁻¹ and less; a first value between 100 s⁻¹ and 1000 s⁻¹ and a second value between 1000 s⁻¹ and 100,000 s⁻¹. The examples of films that have been EB treated (4, 6, and 11) have a cross-link density that is higher than films that are not irradiatively cross-linked (10 and 3). Among the EB treated films (4, 6, and 11), there was not a significant difference in cross-linking when order of treatment is changed (4 vs 6) or in the absence of MD (11).

The gel density comparison by viscosity was determined by capillary viscometry. The capillary viscometry was conducted by using a Dynisco Capillary Rheometer, Model LCR 7000, available from Dynisco Polymer Test, Franklin, Mass., USA. The LabKARS software package was used to collect the data. Die number CX400-20 was used at a temperature of 190° C. with approximately 10 g of film loaded into the charging barrel. A melt time of 6 minutes was used before data was collected. Data was then collected at 9 different shear rate points that ranged from 5 reciprocal seconds (1/s) to 3000 reciprocal seconds (1/s). The shear rate points were logarithmically spaced within this range. An additional data point was collected after the first 9 data points to ensure that polymer degradation did not occur with the samples. The additional data point was collected at the same shear rate as data point 5. None of the samples demonstrated any polymer degradation as the additional data point showed similar shear viscosity as that collected at data point 5. The 10 shear rate points that were used, in this order, were: 5, 11.1, 24.7, 55.1, 122.5, 272.5, 606.2, 1348.5, 3000, and 122.5. The software calculated the shear viscosity at the inputted shear rate points.

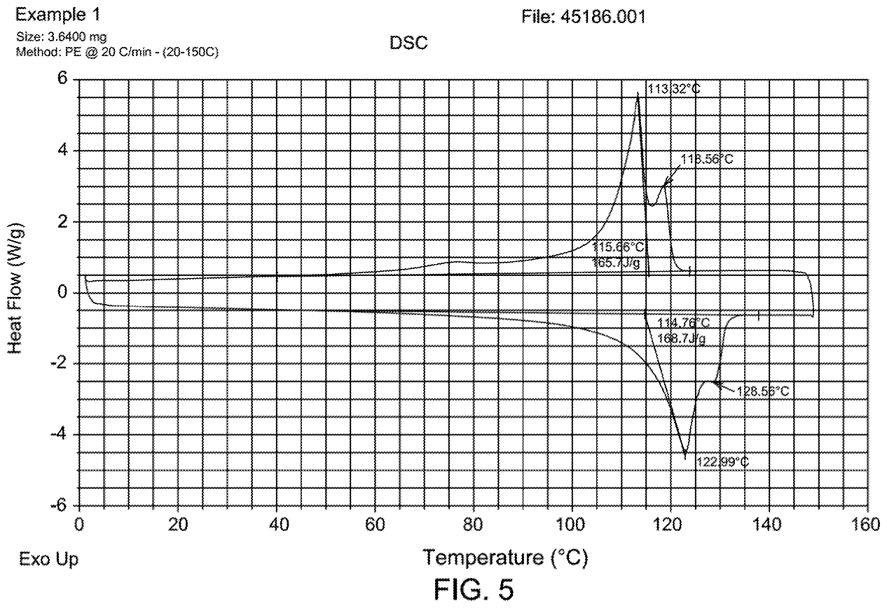

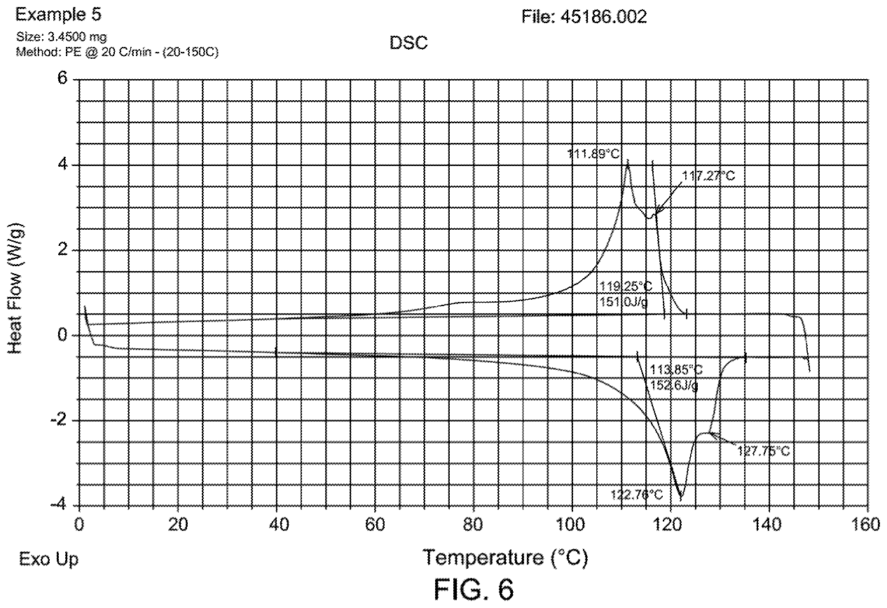

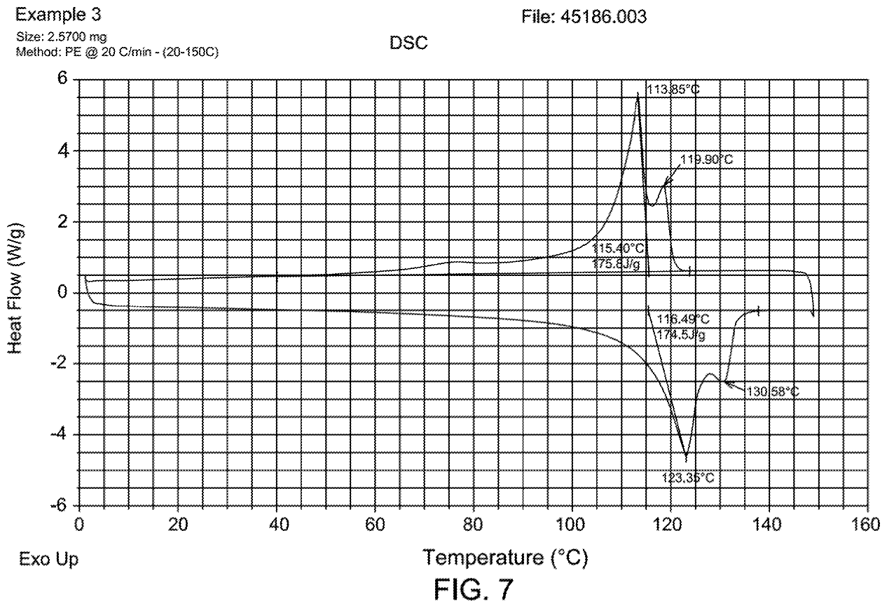

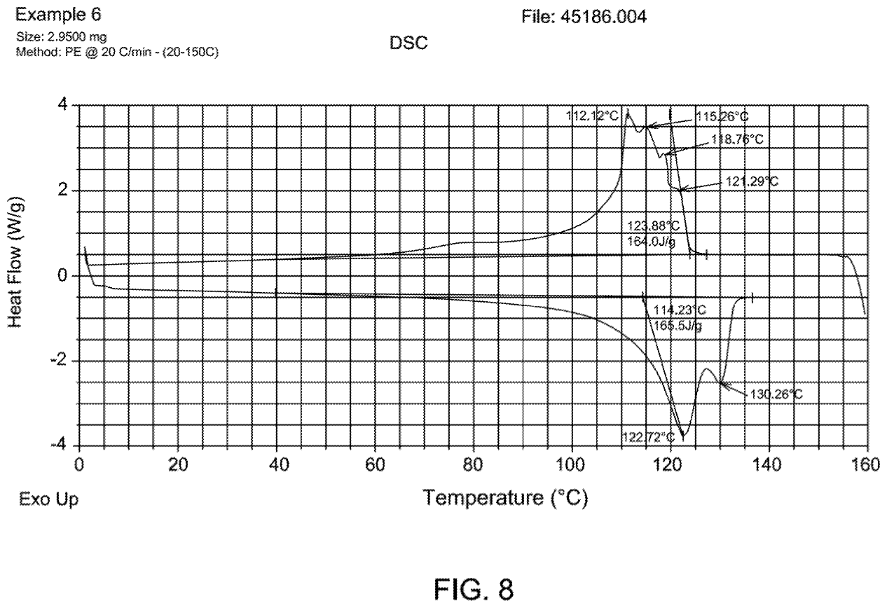

Differential scanning calorimetry (DSC) was measured by ASTM D3418-15, FIGS. 5-8 are DSC graphs of heat flow versus temperature for Examples 1, 5, 3, 6, respectively. FIGS. 5-8 indicate that the MDO and EB treated films maintained a profile consistent with polyethylene.

For loop stiffness measurement, an Instron® tensile tester from Instron Corporation, Norwood, Mass. was used having a 100-pound (approximately 45.36 kilogram) load cell. Specimen samples were prepared by cutting a 4 inch (10.16 cm) by 4 inch (1016 cm) sample of each material and folding opposing ends of the sample towards themselves to form a loop. The folded sample was placed into a specimen holding fixture so that the opposing sides of the sample were separated by a distance of 1.0 inch (2.54 cm). A 0.25 inch (0.635 cm) thick by 5 inch (12.7 cm) long stainless steel test probe was fitted to an Instron® mechanical: testing instrument. The instrument was set to the “stiffness” internal protocol. The amount of force required to bend or deflect the sample approximately 05 inch (1.27 centimeter) at the vertex of the loop was measured.

Results for loop stiffness are provided in Table 2.

TABLE 2

| | MD^{(A)} | | TD^{(B)} | |
|---|---|---|---|---|
| | Thickness | Loop | Thickness | Loop |
| | micron | Stiffness | micron | Stiffness |
| Example | (mils) | grams | (mils) | grams |
| Example 8 | 10.9 (0.44) | 1 ± 0.13 | 11.6 (0.46) | 0.9 ± 0.07 |
| COMPARATIVE | | | | |
| OPET | | | | |
| Example 1 | 33.0 (1.32) | 3.1 ± 0.46 | 30.6 (1.22) | 3.4 ± 0.68 |
| COMPARATIVE | | | | |
| HDPE-mLLDPE/ | | | | |
| MDPE/HDP | | | | |
| E-mLLDPE | | | | |
| MDO, no EB | | | | |
| Example 5 | 30.7 (1.23) | 2.9 ± 0.34 | 30.0 (1.20) | 2.2 ± 0.43 |
| HDPE-mLLDPE/ | | | | |
| MDPE/HDP | | | | |
| E-mLLDPE | | | | |
| MDO followed by EB | | | | |
| Example 3 | 21.3 (0.85) | 2.3 ± 0.43 | 22.9 (0.92) | 1.4 ± 0.33 |
| COMPARATIVE | | | | |
| HDPE/MDPE/HDPE | | | | |
| MDO, no EB | | | | |
| Example 6 | 26.8 (1.07) | 2.8 ± 0.44 | 26.4 (1.06) | 2.2 ± 0.33 |
| HDPE/MDPE/HDPE | | | | |
| MDO followed by EB | | | | |
| Example 4 | — | 3.3 ± 0.41 | — | 3.1 ± 0.29 |
| HDPE/MDPE/HDPE | | | | |
| EB followed by MDO | | | | |
| Example 2 | — | 3.3 ± 0.38 | — | 3.2 ± 0.31 |
| HDPE-mLLDPE/MDPE/ | | | | |
| HDPE-mLLDPE EB | | | | |
| followed by MDO | | | | |

^{(A)}Machine Direction
^{(B)}Transverse Direction

Based on Table 2, the loop stiffness of the inventive treated films are improved over the comparative OPET, When films are first treated with EB followed by MDO, the films display higher stiffnesses than films first oriented then exposed to EB.

Force was derived from Secant & Young's Modulus, which was measured by ASTM D882-12. Tensile strength was measured by ASTM D882-12. Elmendorf Tear was measured by ASTM D1922-15, Instron Puncture was measured by ASTM F1306-16. The data is provided in Table 3.

TABLE 3

| | Tensile | Film | Elmendorf | Resistance |
|---|---|---|---|---|
| | Strength | Puncture | Tear, | Force |
| Example | Newton | Newton | Newton | Newton |
| Example 8 | MD: 51.15; | 19.19 | MD: 0.1568; | MD: 1288; |
| COMPARATIVE | TD: 45.81 | | TD: 0.1764 | TD: 1245 |
| OPET | | | | |
| Example 5 | MD: 74.02; | 3.75 | MD: 0.1764; | MD: 1559; |
| HDPE-mLLDPE/MDPE/ | TD: 18.41 | | TD: 1.0878 | TD: 1053 |
| HDPE-mLLDPE | | | | |
| MDO followed by EB | | | | |
| Example 6 | MD: 29.84; | 6.44 | MD: 0.4312; | MD: 997; |
| HDPE/MDPE/HDPE | TD: 13.16 | | TD: 0.196 | TD: 784 |
| MDO followed by EB | | | | |
| Example 4 | MD: 93.37; | 8.33 | MD: 0.8428; | MD: 1546; |
| HDPE/MDPE/HDPE | TD: 19.39 | | TD: 1.793 | TD: 1055 |
| EB followed | | | | |
| by MDO | | | | |
| Example 2 | MD: 106.49; | 9.87 | MD: 1.421; | MD: 1164; |
| HDPE-mLLDPE/MDPE/ | TD: 21.52 | | TD: 5.3508 | TD: 1218 |
| HDPE-mLLDPE EB | | | | |
| followed by MDO | | | | |

Clarity was measured using the clarity port of a BYKGardner HazeGard in accordance with its instructions and the teaching of ASTM D-1003-13. Clarity is defined as the percentage of transmitted light that deviates from the incident light by less than 2.5 degrees.

Table 4 provides clarity data.

TABLE 4

| Example | Clarity |
|---|---|
| Example 8 | 97.2% |
| COMPARATIVE | |
| OPET | |
| Example 1 | 96.8% |
| COMPARATIVE | |
| HDPE-mLLDPE/ | |
| MDPE/HDP | |
| E-mLLDPE | |
| MDO, no EB | |
| Example 5 | 95.0% |
| HDPE-mLLDPE/ | |
| MDPE/HDP | |
| E-mLLDPE | |
| MDO followed by EB | |
| Example 3 | 95.4% |
| COMPARATIVE | |
| HDPE/MDPE/HDPE | |
| MDO, no EB | |
| Example 6 | 96.6% |
| HDPE/MDPE/HDPE | |
| MDO followed by EB | |

Heat shrinkage test is defined to be values obtained by measuring unrestrained shrink at 90° C. for five seconds. Four test specimens are cut to 10 cm. in the machine direction by 10 cm, in the transverse direction. Each specimen is completely immersed for 5 seconds in a 90° C. water bath (or other specified nonreactive liquid). The distance between the ends of the shrunken specimen is measured. The difference in the measured distance for the shrunken specimen and the original 10 cm. is multiplied by ten to obtain the percent of shrinkage for the specimen for each direction. The MD shrinkage for the four specimens is averaged for the machine direction shrinkage value of the given film sample, and the TD shrinkage for the four specimens is averaged for the transverse direction shrinkage value.

With respect to Examples 2, 4, 5 and 6, shrinkage along MD in 90° C. water bath was about 78%. There was no shrinkage along TD, (MD=machine direction, TD=Transverse/cross direction).

Unless otherwise indicated, all numbers expressing quantities of ingredients, properties such as thickness, force, loop stiffness, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Reference throughout this specification to “one embodiment,” “certain embodiments,” “one or more embodiments” or “an embodiment” means that a particular feature, structure, material, or characteristic described in connection with the embodiment is included in at least one embodiment of the disclosure, Thus, the appearances of the phrases such as “in one or more embodiments,” “in certain embodiments,” “in one embodiment” or “in an embodiment” in various places throughout this specification are not necessarily referring to the same embodiment of the disclosure. Furthermore, the particular features, structures, materials, or characteristics may be combined in any suitable manner in one or more embodiments.

Although the disclosure herein has been described with reference to particular embodiments, it is to be understood that these embodiments are merely illustrative of the principles and applications of the present disclosure. It will be apparent to those skilled in the art that various modifications and variations can be made to the method and apparatus of the present disclosure without departing from the spirit and scope of the disclosure. Thus, it is intended that the present disclosure include modifications and variations that are within the scope of the appended claims and their equivalents.

1. A recyclable film for packaging a product having a composition comprising a polyethylene, the film being oriented and irradiatively cross-linked and having a shrink rate of 10% or less upon application of heat equal to 90° C.

2. The recyclable film of claim 1, wherein the composition is selected from the group consisting of: high density polyethylene, medium density polyethylene, low density polyethylene, linear low density polyethylene, and combinations thereof.

3. The recyclable film of one claim 1 having a clarity of at least 95%

4. The recyclable film of claim 1, wherein change in apparent shear viscosity is substantially constant over an apparent shear rate in the range of 1 s⁻¹ to 100,000 s⁻¹.

5. The recyclable film of claim 1, wherein an outer surface of the film has a cross-link density that is higher than a comparative outer surface of a comparative outer film comprising the polyethylene that is not irradiatively cross-linked.

6. The recyclable film of claim 1, wherein onset of sticking by an outer surface of the film upon exposure to heat sealing conditions is at least 5 to 15° C. higher than a comparative outer surface of a comparative outer film comprising the polyethylene that is not irradiatively cross-linked.

7. The recyclable film of claim 1 having a shrink rate of 7% or less upon application of heat equal to 90° C.

8. The recyclable film of claim 1 comprising a monolayer of one type of polyethylene or a blend of two or more types of polyethylene.

9. The recyclable film of claim 1 comprising a coextruded multilayered laminate.

10. The recyclable film of claim 9, wherein the coextruded multilayered laminate comprises a medium density polyethylene layer positioned between an outer high density polyethylene layer and an inner high density polyethylene layer.

11. The recyclable film of claim 10, wherein the outer and inner layers of the coextruded multilayered laminate further comprise a linear low density polyethylene.

12. A multilayer film for packaging a product comprising:
an outer film comprising the recyclable film of claim 1;
a sealant layer or film; and
optionally one or more inner layers located between the outer film and the sealant layer or film.

13. The multilayer film of claim 12, wherein the sealant layer comprises a polyolefin.

14. The multilayer film of claim 12, wherein the outer film and the sealant layer are coextruded.

15. The multilayer film of claim 12, wherein the sealant film comprises at least a polyolefin layer.

16. The multilayer film of claim 12, wherein the outer film and the sealant film are laminated by heat, extrusion, or by adhesive.

17. The multilayer film of claim 12 having a thickness in the range of about 12.5 microns (0.5 mil) to about 380 microns (15 mils).

18. The multilayer film of claim 12 further comprising printed indicia.

19. A package for food and/or beverage comprising the recyclable film of claim 1.

20. The package of claim 19 in the form of a pouch comprising one or more sidewalls formed from the multilayer film.

21-24. (canceled)
